(19) United States
(12) Patent Application Publication
(10) Pub. No.: US 2002/0198696 A1
(43) Pub. Date: Dec. 26, 2002

(54) Method and apparatus for designing and making an integrated circuit

(76) Inventors: Hector Sanchez, Cedar Park, TX (US); Karen Delk, Cedar Park, TX (US); Xinghai Tang, Cedar Park, TX (US); Pradipto Mukherjee, austin, TX (US)

Correspondence Address: MOTOROLA INC, AUSTIN INTELLECTUAL PROPERTY, LAW SECTION, 7700 WEST PARMER LANE MD: TX32/PL02, AUSTIN, TX, 78729

(21) Appl. No.: 09/877,792

(22) Filed: Jun. 8, 2001

(51) Int. Cl. G06F 17/50

(52) U.S. Cl. 703/14

(57) ABSTRACT

An integrated circuit is made by utilizing a delay and/or capacitance model and/or setup/hold time model which provides for the ability to isolate issues of transistor performance, metallization capacitance, metallization resistance, power supply voltage, and temperature for the individual design blocks that make up the integrated circuit. This is achieved by utilizing an equation representative of these performance characteristics as certain variables in the equation. The equation also has constants which are determined by first running the design blocks through a standard circuit simulator. The result is a different set of these constants for each design block. Various signal paths are made up of various design blocks so that each path can be analyzed by analyzing the performance of the individual blocks that make up the path. Thus, areas of improvement for the design blocks are more easily identified prior to actually making the integrated circuit.

### FIELD OF THE INVENTION

The present invention relates to integrated circuits, and more specifically to a method of designing and making an integrated circuit.

### RELATED ART

During the design of integrated circuits, static timing analyzers may be used to determine the delays and edge rates through various paths within the integrated circuit. However, valuable time to market is being lost by having to redesign these integrated circuits due to changing manufacturing technologies such as changes in metallization resistance and capacitance (i.e. metallization RC), supply voltage, process, and temperature specifications. These redesign efforts are costly from both a time to market perspective as well as a resource perspective.

For example, FIG. 1 illustrates one prior art method of modeling a design block within an integrated circuit to determine the delay. FIG. 1 utilizes an input parameter, Tx, which corresponds to the input edge rate, as well as the output capacitive loading, Cl. In modeling the time delay, a single nominal point is chosen thus giving a specific value for the metallization RC, the supply voltage, process, and temperature. Once the blocks are modeled using a circuit simulator, the final integrated circuit design is verified through the use of a static timing analyzer. If any changes have been made to the operating parameters, such as the metallization RC, process, supply voltage, or temperature, new models must be created and reanalyzed at a different nominal point which increases time to market and cost.

For example, a timing rule currently used in the art today evaluates an equation in the form of equation 1 below:

Delay=(K1+K2·Cl)·Tx+K3·Cl²+K4·Cl+K5 Equation 1

This equation may also be referred to as the Five Coefficient Timing Rule equation. Note that this delay equation is dependent only upon the input edge rate, Tx, and the capacitive load at the output, Cl. Therefore, multiple timing rules are needed to evaluate the integrated circuit at other operating points (i.e. at different metallization RCs, supply voltages, process, or temperature points). Therefore, the above delay equation only holds for one particular operating point. In order to prevent costly redesigns, a need exists for timing rule equations that are dependent upon supply voltage, metallization RC, process, and temperature, as well as edge rate and capacitive loading. Therefore, a same timing rule may be used to evaluate time delays under various operating conditions without having to go through costly redesign procedures.

### BRIEF DESCRIPTION OF THE DRAWINGS

The present invention is illustrated by way of example and not limitation in the accompanying figures, in which like references indicate similar elements, and in which:

FIG. 1 illustrates a prior art implementation of a circuit block model.

FIG. 2 illustrates a circuit block model in accordance with one embodiment of the present invention.

FIG. 3 illustrates an example of a model of FIG. 2, according to one embodiment of the present invention.

FIGS. 4-7 illustrate simplified versions of the model of FIG. 3, according to various embodiments of the present invention.

FIG. 8 illustrates, in flow diagram form, one method for utilizing the model of FIG. 2.

Skilled artisans appreciate that elements in the figures are illustrated for simplicity and clarity and have not necessarily been drawn to scale. For example, the dimensions of some of the elements in the figures may be exaggerated relative to other elements to help improve the understanding of the embodiments of the present invention.

### DETAILED DESCRIPTION

As used herein, the term “bus” is used to refer to a plurality of signals or conductors which may be used to transfer one or more various types of information, such as data, addresses, control, or status. The terms “assert” and “negate” is used when referring to the rendering of a signal, status bit, or similar apparatus into its logically true or logically false state, respectively. If the logically true state is a logic level one, the logically false state is a logic level zero. And if the logically true state is a logic level zero, the logically false state is a logic level one.

Brackets is used to indicate the conductors of a bus or the bit locations of a value. For example, “bus 60 [0-7]” or “conductors [0-7] of bus 60” indicates the eight lower order conductors of bus 60, and “address bits [0-7]” or “ADDRESS [0-7]” indicates the eight lower order bits of an address value. The symbol “$” preceding a number indicates that the number is represented in its hexadecimal or base sixteen form. The symbol “%” preceding a number indicates that the number is represented in its binary or base two form.

In determining delay times of an integrated circuit, the integrated circuit may be broken down hierarchically into integrated circuit subsets (or design blocks). In order to understand the timing delays of an entire integrated circuit, the delay time through each integrated circuit subset in addition to the input capacitance and the setup/hold times of circuit blocks can be expressed as a function of various operating parameters such as metallization resistance and capacitance (i.e. Rint and Cint, respectively), supply voltage (i.e. Vdd), process (i.e. transistor performance), and temperature. Therefore, if the sensitivities of delay time, input capacitance, and setup/hold time are characterized in terms of these operating parameters, the timing delay of the integrated circuit and its subsets can better be understood and modeled.

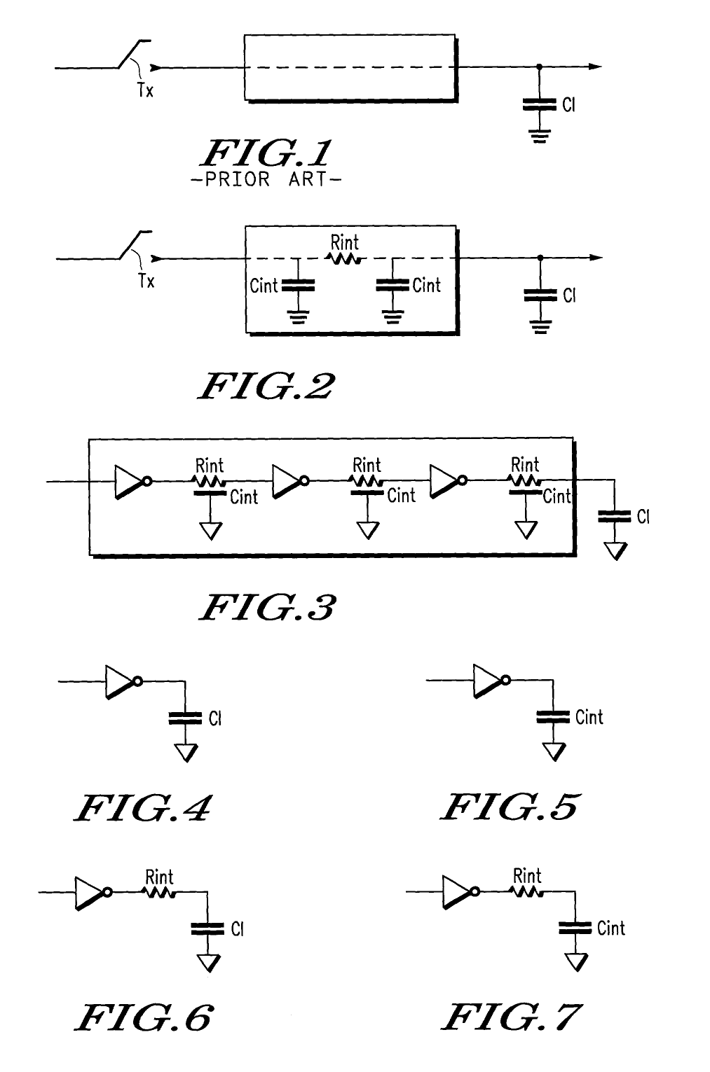

FIG. 2, for example, illustrates a model of a design block within an integrated circuit according to one embodiment of the present invention. Unlike the model of FIG. 1, the model of FIG. 2 includes additional parameters such as metallization resistance (Rint) and capacitance (Cint) in addition to Tx (input edge rate or transition time) and Cl. As discussed above, an integrated circuit may be broken down hierarchically into subset blocks. These blocks may each include multiple blocks down to a single component level or be a combination of many components such as an adder, multiplexer, cache, etc. Therefore, one example of an integrated circuit that may be found in the block of FIG. 2 is illustrated in FIG. 3. That is, there may be multiple components, illustrated here as inverters where the inverters may be any single component or collection of components that are coupled to each other by internal metal lines. Each of these internal metal lines has resistive and capacitive components that affect delay through the block. Also, there is metal lying at the output stage, illustrated in FIG. 3 at the output of the last inverter, which is coupled to the capacitive load. This metallization at the output also affects delay through the block of FIG. 3 and can be taken into consideration. The block of FIG. 3 can also be thought of as comprising three separate blocks, each of them including a single inverter and an output metal line having metallization RC components. Therefore, as used herein, Rint and Cint refer to the metallization RC, respectively. Note that metallization RC can also be referred to as internal RC or distributed RC.

Embodiments of the present invention relate to a timing rule that incorporates not only input edge rates and output capacitive loads but also supply voltage (Vdd), metallization (i.e. internal, distributed) resistance and capacitance (Rint and Cint), process, and temperature (Temp). Therefore, equation 2 shows a timing rule according to one embodiment of the present invention.

Delay=(K0·Tx^{-0.5}+K1·Tx+K2·Cl^{cl}^{_{—}}^{tx}·Tx+K3·Cl^{cl}^{_{—}}^{exp}+K4·Cl+K5+K6·Rint·Cl+K7·Rint·Cint +K8·Cint+K9·Cint^{cin}^{_{—}}^{exp}+K10·Cint^{cin}^{_{—}}^{tx}·Tx)·(K11·Temp^{temp} ^{_{—}}^{exp}+K12·Temp+K13)·(K14·Process^{proc}^{_{—}}^{exp}+K15·Process·Vdd²+K16·Process·Vdd+K17·Process+K18·Vdd^{volt}^{_{—}}^{exp}+K19·Vdd+K20)−K21 Equation 2:

For each design block, the constants K0-K21 are determined so as to provide a more complete timing rule, as will be discussed below. In order to better understand the makeup of equation 2, the equation will be decomposed into different sections and discussed with respect to the various circuit sensitivities. (That is, the delay equation can be decomposed into a variety of different delay expressions.) For example, the sensitivity of delay to internal resistance and capacitance may be analyzed separately from the sensitivities to process, Vdd, and temperature. Also, some of the constants relating to some sensitivities can be derived using physical models (as will be discussed in references to FIGS. 4-7) while others can be derived by studying the circuit's behavior. Through the concept of superposition, these sensitivities can then be combined to form the complete equation of equation 2, as will be seen below. For example, equation 3 illustrates a timing rule equation that is dependent upon the metallization resistance and capacitance (Rint and Cint) of a circuit block being analyzed:

Delay=K0·Tx^{-0.5}+K1·Tx+K2·Cl^{cl}^{_{—}}^{tx}·Tx+K3·Cl^{cl}^{_{—}}^{exp}+K4·Cl+K5+K6·Rint·Cl+K7·Rint·Cint+K8·Cint+K9·Cint^{cin}^{_{—}}^{exp}+K10·Cint^{cint}^{_{—}}^{exp}·Tx Equation 3:

Notice that the above delay equation takes into consideration metallization resistance and capacitance in addition to input edge rates and capacitive load. The constants K1-K5 are representative of the terms used in the Five Coefficient Timing Rule equation of equation 1. That is, constants K1-K5 correspond to the model of FIG. 4, which is a simplified model of FIG. 3 where an input edge rate is driving an output capacitive load, and the metallization resistance and capacitance is assumed negligible. This is the same model used in deriving the prior art Five Coefficient Timing Rule of equation 1. However, within the portion of equation 3 relating to K1-K5, the exponents cl_tx and cl_exp are no longer fixed at 1 and 2 respectively, as they were in Equation 1. The ability to set these exponents allows for a more accurate determination of constants K2 and K3 while requiring less runs through a circuit simulator in deriving the constants, as will be discussed below. (In one embodiment, cl_tx and cl_exp are set to 0.5 and 1.5, respectively.) The delay through a circuit block, such as that of FIG. 4, has a nonlinear dependency upon input edge rates, thus the first term, corresponding to constant KO (i.e. K0·Tx^{-0.5}), represents a curve fitting term due to this nonlinearity. The K0·Tx^{-0.5} term therefore allows for better curve fitting in deriving an equation that models delay based on Cl and Tx. (Also note that in alternate embodiments, numerical exponents may have different values than those used here.)

Through the principle of superposition, a model can be broken down into various elements of resistance and capacitance in order to derive the terms relating to K6-K10. For example, a first model of an integrated circuit, or portion thereof, may assume a driver driving a capacitive load, where the capacitive load may be representative of the metallization capacitance of the model, as illustrated in FIG. 5. This metallization capacitance (Cint) can include the capacitance internal to the model, such as the metal between components, or the metal capacitance at the output of the circuit block. In this example, the metal resistance is assumed to be negligible; therefore, constants relating to the metallization capacitance may be derived. Note that this model of FIG. 5 is similar to the previous model discussed, FIG. 4, where a driver is simply driving a capacitive load. Therefore, the terms associated with K1-K5 which relate to the model of FIG. 4 may be used to derive the terms relating to delay caused by the metallization capacitance, as modeled by FIG. 5.

Therefore, in the portion of the equation relating to constants K1 to K5, each term that is effected by the capacitive load is used to derive a term which is effected by the metallization capacitance. For example, the term corresponding to the constant K2 is dependent upon the capacitive load. Therefore, a term similar to the K2 term is included in the equation 3. This term is represented by K10·Cint^{cin}^{_{—}}^{tx}·Tx. Note that this term is similar in form to the term containing K2. In the portion of the equation relating to constants K1 to K5, the K3 term is also dependent upon the capacitive load. Therefore, another term is added to the equation that is similar in form to this K3 term: K9·Cint^{cint}^{_{—}}^{exp}. (Note that in one embodiment, cint_tx is 0.25 and cint_exp is 1.) Likewise, the K4 term is dependent upon Cl, therefore another term similar in form to the K4 term is included in the equation: K8·Cint. Therefore, the terms corresponding to constants K8, K9, and K10 are similar in form to those corresponding to constants K4, K3, and K2, respectively, since a model having a metallization capacitance and a negligible metallization resistance (such as FIG. 5) looks and behaves similar to a model of a driver driving a capacitive load (such as FIG. 4). The similarity in these models also results in a similarity between the curve fitting terms of each model.

The term relating to the constant K6 can be thought of as being derived from FIG. 6 which illustrates a model having an output metallization resistance, Rint, that is coupled to the capacitive load, Cl (while assuming that the metallization capacitance is negligible). Therefore, through superposition, another term is added to the delay equation (e.g. equation 3) to incorporate this relationship: K6·Rint·Cl. However, if a circuit block has a negligible output stage metallization resistance, this term effectively goes to zero and essentially results in no effect on the delay equation.

The term corresponding to K7 in equation 3 models any internal metallization resistance or capacitance within the circuit block. For example, FIG. 3 may be modeled as FIG. 7 where the capacitive load may be assumed to be negligible. Therefore, the K7 term, K7·Rint·Cint, provides for any internal delay caused by the metallization within the circuit block. In alternate embodiments, the term corresponding to K7 can be expressed as K7·Rint^{rint}^{_{—}}^{exp}. Cint where the rint_exp exponent can be set to different values.

As seen above, equation 3 takes into consideration not only the input edge rates and output capacitive load but any internal metallization resistance and capacitance in calculating delay. The terms corresponding to constants K5-K10 thus provide the intrinsic delay of the circuit block. That is, each of these terms corresponds to delay caused by an internal resistance or capacitance factor (including Rint and Cint). Also note that in the timing equation of equation 2 or 3, more or less terms may be used to achieve more accurate curve fitting equations at a cost of requiring more runs and constants. Also, some of the terms within the equation may be taken out depending upon the needs of the design. For example, in analyzing a circuit block that includes an array, the terms corresponding to the input edge rate (such as the terms having constants K0, K1, K2, and K10) may be removed from the equation since they would be essentially negligible. Therefore, the equation may be expanded or reduced depending upon the needs of the circuit design. Likewise, the terms used in equations 2 and 3 can include more or less exponents within the terms. For example, as mentioned above, the term corresponding to K7 may utilize an exponent (e.g. rint_exp).

Equation 3 illustrates how the internal metallization resistance and capacitance are derived according to physical models of the circuit block (FIGS. 4-7). The elements of temperature, process, and Vdd also affect delay time through the circuit block, and through superposition, terms reflecting the effects of these elements may be added to equation 3 to produce the more complete timing rule of equation 2. Generally the process parameter represents transistor performance fluctuations due to manufacturing process variations, and the temperature parameter represents the operating temperature of the circuit. However, since these operating parameters are more difficult to physically model, terms may be included in equation 2 by studying their characteristics and applying curve-fitting methods. For example, the terms corresponding to constants K11-K13 correspond to the temperature dependence of the circuit block. These three terms are used to curve fit the delay sensitivity of the circuit block with respect to temperature. Likewise, in one embodiment, the process and Vdd sensitivities are combined into the terms corresponding to constants K14-K20. That is, the terms corresponding to constants K14-K20 provide curve-fitting terms to model the sensitivity of the delay through the circuit block with respect to both process and Vdd. Once again, more or less terms may be utilized to achieve a better curve fit or to reduce terms for simplified processing. For example, in an alternate embodiment, the process and Vdd sensitivities may be modeled separately, resulting in a separate set of terms and constants for each sensitivity. Alternatively, other sensitivities (i.e. operating parameters) may be combined in order to reduce terms and constants from the timing rule equation. (Note that in one embodiment of the present invention, temp_exp, proc_exp and volt_exp may each be set to 2; however, they are represented as variables in order to allow more flexibility in these terms. Also note that any numerical exponents may also be changed as needed.)

Equation 2 also includes a final constant, K21. This constant may be utilized to ensure that every result of equation 2 provides a positive delay in order to properly solve the equations using logarithm transformations which converts equation 2 to a linear equation. For example, K21 may be used in the final computation to shift the delay back to the original starting position. Alternatively, if the above equation is solved using different methods that do not require logarithmic calculations, the constant K21 may be left out. Therefore, K21 does not relate to the delay of the circuit diagram but is used to simplify the mathematics which may be used to solve the above equation.

Just as the delay through a circuit block may be dependent on various delay factors such as metallization RC, process, Vdd, and temperature, the same is so for the input capacitance of a circuit block. The following equation (equation 4) illustrates the sensitivities of the input capacitance (CapI) of a circuit block with respect to various capacitance factors such as input edge rate, output capacitive load, process, Vdd, temperature, and metallization resistance and capacitance. (Note that the following equation may also be decomposed into a variety of different capacitance expressions to better understand the complete equation.)

CapI=K0·Process^{exp1}+K1·Vdd^{exp2}+K2·Temp^{exp3}+K3·Process·Vdd+K4·Process·Temp+K5·Vdd·Temp+K6·Process+K7·Vdd+K8·Temp+K9·Cint+K10Rint+K11·Cl+K12·Tx+K13·Process·Vdd·Temp+K14 Equation 4:

The terms relating to constants K10, K11 and K12 are used to illustrate how the perceived input capacitance of a circuit block changes with respect to metallization resistance, the output capacitive load, and the input edge rate, respectively. For example, as the output capacitive load varies, the perceived input capacitance may also vary accordingly. The same applies for the internal metallization resistance and the input edge rates.

The term corresponding to K9 reflects the variance in the internal metallization capacitance and how this affects the perceived input capacitance of the circuit block. The constant K14 represents a transistor term. That is, if it is assumed within the circuit block that the metallization resistant and capacitance is negligible, then the K14 term corresponds to the input capacitance of the transistor itself. Therefore, the K14 constant is modulated by the remaining terms in the equation as the operating points (metallization RC, process, Vdd, temperature, etc.) vary.

As described above in reference to the timing delay equations, due to the difficulties in physically modeling the sensitivities of the input capacitance to the parameters such as process, Vdd, and temperature, terms are included in the equation in order to curve fit these non-linearities and express the sensitivities of CapI to these parameters. Therefore, the terms corresponding to the constants K0, K1, and K2 (having exponents exp1, exp2, and exp3, respectively) represent the non-linear curve fitting terms corresponding to process, Vdd, and temperature, respectively. In one embodiment, these exponents have been determined to be 3, 3, and 2, respectively. (However, in alternate embodiments, they may have different values.) The terms corresponding to constants K6, K7, and K8 represent the linear terms used to curve fit the sensitivities of process, Vdd, and temperature respectively. Therefore, constants K0-K2, K6-K9, and K14 are used to model the sensitivities of CAP I to process, Vdd, temperature, metallization resistance and capacitance, input edge rate, and output capacitive load.

The terms corresponding to constants K3-K5 and K13 may be utilized to cover those integrated circuits that utilize silicon-on-insulator (SOI) technologies. These terms are used to model the sensitivities to the internal bipolar current events. For example, in the case of unprotected input pass gates, such as, for example, a multiplexer (MUX), one path may be turned on and driving a gate while other paths may be turned off. Although the non-selected paths are turned off, the inputs to these paths may be continuously switching. This causes a bipolar effect to draw current away from the selected path which may be modeled as a capacitance that is proportional to e^{V/T} (i.e. the integration of current with respect to time). However, in order to mathematically handle the exponential term, the exponential (e^{V/T}) may be expanded using a Taylor series expansion which provides the terms corresponding to constants K3-K5 and K13. Therefore, in one embodiment, if the integrated circuit being modeled utilizes only bulk silicon transistors, these terms may be removed from the equation. However, these terms may be kept within the equation for more accurate curve fitting. That is, even in the case of bulk silicon transistors utilized in unprotected input pass gates, the capacitance may be affected by process, temperature, and Vdd thus requiring similar terms to model such behavior. Since the effect may be much smaller in the case of bulk silicon transistors than with SOI transistors, these terms may be negligible in the former case while required in the latter case. Therefore, this input capacitance, CapI, may be used as the capacitive load for previous circuit blocks during timing analysis of an integrated circuit.

Similarly, setup/hold time for a circuit block may also be dependent on various setup/hold time factors such as metallization RC, process, Vdd, and temperature. The setup/hold times generally refer to how long before and after a reference signal the data must be ready at the input of a circuit block. For example, in one embodiment, the reference signal is a clock signal that latches the input value into the circuit block, where the data must be ready for a predetermined amount of time prior to the clock signal edge (e.g. setup time) and remain valid for a predetermined time after the clock signal edge (e.g. falling time). Therefore, the following equation (equation 5) illustrates the sensitivities of the setup/hold time of a circuit block with respect to input edge rate, output capacitive load, process, Vdd, temperature, and metallization resistance and capacitance. Note that RefTx refers to the input edge rate of the reference signal (such as, for example, a clock signal) while Tx may be referred to as the input edge rate of the data signal. (Also note that the following equation can also be decomposed into a plurality of setup/hold time expressions to better understand the complete equation.)

setup/hold_time=K0+K1·Tx+K2·RefTx+K3·Process+K4·Vdd+K5·Temp+K6·Rint+K7·Cint+K8·Cl+K9·RefTx^{exp0}+K10·Vdd^{exp1}+K11·Process^{exp2}+K12·Vdd^{exp3}·Process^{exp4}+K13·Rint^{exp5}·Cint^{exp6}·K14 Equation 5:

The terms relating to constants K1 and K2 correspond to how setup/hold times are affected with respect to the input edge rate and the reference signal input edge rate, respectively. K0 refers to the intrinsic setup/hold time for the circuit block. Therefore, the terms relating to K0, K1, and K2 can be used to model setup/hold times for a prior art circuit model such as FIG. 1 since these three terms include variables relating only to input edge rates. The remaining constants reflect how setup/hold times are affected with respect to other operating parameters such as output capacitive load, process, Vdd, temperature, and metallization resistance and capacitance.

The terms relating to K6 and K7 each illustrate how setup/hold times are affected by metallization resistance and capacitance, respectively. The term relating to K8 illustrates how setup/hold times are affected by the output capacitive load. Note that only one term in equation 5 is dependent upon output capacitive load since the output capacitive load does not generally impact setup/hold time of the circuit block. Terms relating to K1-K8 may therefore be derived using the simplified physical models of FIGS. 4-7, as described above with reference to equation 2.

However, as described above in reference to the timing delay equation and CapI equation, due to the difficulties in physically modeling the sensitivities of the setup/hold times to parameters such as process, Vdd, and temperature, linear and non-linear terms are included in equation 5 in order to express and curve fit these sensitivities. The terms corresponding to constants K3, K4, and K5 represent the linear terms used to curve fit the sensitivities of process, Vdd, and temperature, respectively. The terms corresponding to the constants K10 and K11 (having exponents exp1 and exp2, which, in one embodiment, are determined to be −3 and −2, respectively) represent the non-linear curve fitting terms corresponding to Vdd and process. The term corresponding to K12 represents the nonlinear relationship between Vdd and process and how this relationship affects setup/hold times. Therefore, exponents (exp3 and exp4) are used to help model this relationship. In one embodiment, exp3 and exp4 are determined to be −1 and −2, respectively.

The term corresponding to K9 is also a curve fitting term used to express the non-linearity of the input edge rate of the reference signal. Therefore, the exponent exp0 is included in this term. In one embodiment, exp0 is determined to be 2. The term corresponding to K13 represents the relationship of the metallization RC (Rint and Cint) to the setup/hold time. Exponents (exp5 and exp6) are also used here to express the nonlinearity of this relationship. In one embodiment, exp5 and exp6 are each determined to be 1. As described in reference to K21 for equation 2, K14 is a curve fitting term utilized to simplify the mathematics involved in solving the resulting system of equations. For example, when solving for the constants K0-K13, K14 generally ensures that the resulting setup/hold times are always positive. Therefore, alternate embodiments may not utilize K14. As with equation 2 and equation 4, equation 5 may include more or less terms (thus resulting in more or less constants), depending upon the accuracy desired. Similarly, as with equation 2, the terms within equations 4 and 5 may also include more or less exponents, as needed. Also note that the numerical exponents given in equations 2-5 may be changed, as needed.

In the timing delay rule of Equation 2 above, the exponents cl_tx, cl_exp, cint_exp, cint_tx, proc_exp, and volt_exp are not set to any particular value. This allows a user to derive the exponent values that will provide the desired accuracy. (Also note that in alternate embodiments, those numerical exponents that are not expressed as variables may also have different values.) Therefore, in one embodiment of the present invention, the values of these exponents are determined by using simplified circuit models that isolate the critical terms. The critical terms refer to those terms whose exponent is currently being evaluated. For example, by zeroing the input edge rate, the output capacitance, and the metallization (internal) resistance, a model such as that illustrated in FIG. 5 can be achieved where the only terms left in the equation are those corresponding to constants K8, K9 and K5. Furthermore, in order to determine K5, the internal metallization capacitance may also be zeroed out. Therefore, the constant K5 can be determined by using a simplified model with negligible internal metallization resistance and a negligible output capacitance load at the fastest edge rate possible. This provides the intrinsic delay of the transistor itself.

Once having the value of K5, the internal metallization capacitance can be added back into the equation which once again reduces the equation to those terms corresponding to constant K5, K8, and K9. Therefore, a model such as that illustrated in FIG. 5 may be used to supply data in order to solve for constants K8, K9 and the exponent of the term containing K9. Once these values are determined and substituted back into the reduced equation, this reduced equation can be applied to a more complicated circuit in order to verify the accuracy of the chosen constants K8 and K9 and of the exponent cint_exp. If the value is determined to be insufficiently accurate, more data may be taken using the simplified model (e.g. FIG. 5) in order to produce a more accurate exponent. If the exponent is determined to be sufficiently accurate, then the same process is repeated to determine the remaining exponents in the equation. By using simplified models (such, for example, those in FIGS. 4-7) and systematically isolating particular terms within the equation, each of the exponents may be derived. The same analysis used above to derive the exponents for the timing rule of equation 2 can also be applied to derive any exponents for the input capacitance equation (equation 4) and the setup/hold time equation (equation 5), if necessary. Alternate methods may also be used to derive the exponents of equations 2, 4, and 5, such as, for example, various empirical methods for determining the values.

Once these exponents are derived, they are inserted into the timing rule equation of FIG. 2, thus leaving 21 constants yet to be determined. As will be described below, sufficient data are collected to determine the remaining 21 constants by choosing operating points that aid in systematically zeroing out particular elements of the circuit model in order to isolate terms containing the critical constants (those constants currently being evaluated).

In order to collect sufficient data to derive the constants of the equations, at least 21 runs must be performed by a circuit simulator in order to provide sufficient data to solve the 21 unknown equation. That is, at least 21 data points are needed to fully solve the equations. However, these 21 points may be chosen at varying values of metallization resistance and capacitance, Vdd, temperature, process, Tx and Cl in order to provide data for evaluating the equation constants. Therefore, smaller, simpler circuits (as in the case of deriving the exponents) may be used to determine the optimal 21 operating points to use. These points may be chosen such that at least one point focuses on one or more of the critical constant values. For example, the table below illustrates one embodiment of how the constants may be set in order to properly isolate given constants.

| To obtain these constants: | Zero out these processing parameters: |
|---|---|
| K5 | Tx, Cl, Rint, Cint |
| K3, K4 | Tx, Rint, Cint |
| K8, K9 | Tx, Cl, Rint |
| K6 | Tx, Cint |
| K7 | Tx, Cl |
| K0, K1 | Cl, Rint, Cint |
| K10 | Cl, Rint (also use K0 and K1) |
| K2 | Rint, Cint |

For example, in order to obtain K3 and K4, the values of input edge rate and metallization resistance and capacitance may be zeroed out while the process, Vdd, and temperature may be set to a nominal operating point. This point will provide a method for calculating K3 and K4. Note that in deriving these 21 operating points, nominal values for process, Vdd, and temperature may be used; however, these process, Vdd, and temperature values may be adapted to obtain the intrinsic behavior of the constant being determined. For example, points can be chosen for best case processing, high voltage, or cold temperatures.

Once the 21 operating points are chosen, they may be verified on more complicated circuits to determine the accuracy of the 21 chosen points. (Generally, the chosen points do not need to be any more accurate than the circuit simulator models, such as, for example, Spice models, themselves, which may, in one embodiment, be within 5% tolerance from actual silicon.) If these 21 points are deemed to be of insufficient accuracy, different points may be chosen using the simpler circuit once again and then verified on the more complicated circuits. Once the 21 points are of sufficient accuracy to be applied to the entire integrated circuit, a circuit simulator may be run at most 21 times for each circuit block in order to determine the constants for the corresponding timing rule of each circuit block. Therefore, while time may be spent up front to best determine the exponents and the 21 operating points to be used to gather data for deriving the constants, more efficient circuit simulations may be run on the remaining integrated circuit.

These same 21 operating points chosen for use in the timing rule of equation 2 may be used for the input capacitance (CapI) of equation 4 or setup/hold time of equation 5. The CapI equation given above includes 14 constants, and therefore, at least 14 points are required to solve for the 14 unknowns. Therefore, either all 21 points chosen for the timing rule of equation 2, or a subset thereof, may be used to derive the constants of the CapI equation. Alternate embodiments may analyze the CapI equation separately and choose a different set of operating points from those chosen for the timing rule. Similarly, the same points chosen for equation 2 or 4 can be used to derive the constants of the setup/hold time equation. Alternatively, the setup/hold time equation may be analyzed separately and use a subset of or an entirely different set from the operating points for equations 2 and 4. Also, the number of operating points required for solving each equation for the timing rule of equation 2, CapI of equation 4, or setup/hold time of equation 5 depends upon the number of unknown constants within each equation. As described above, each of the three equations may include more or less terms having corresponding constants depending upon varying factors such as, for example, the number of curve fitting terms desired in each equation.

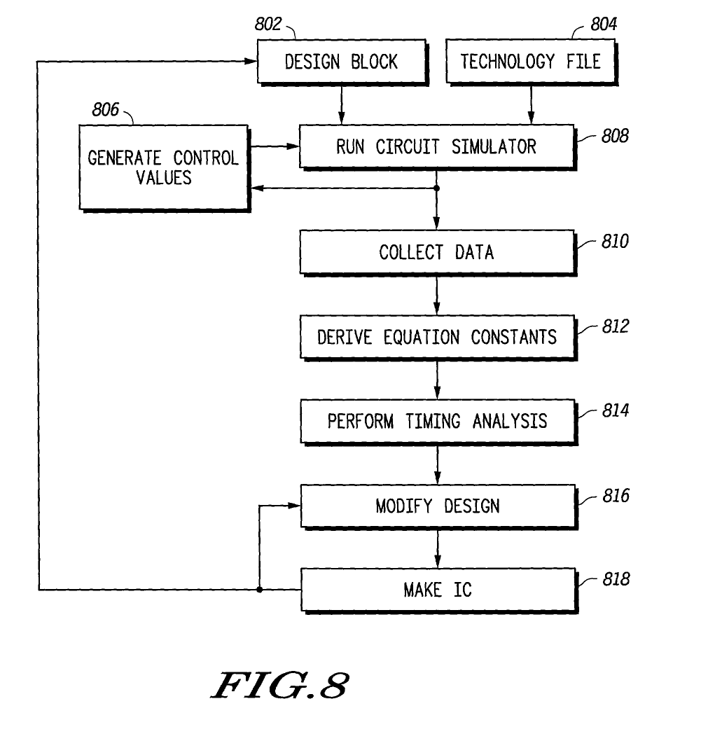

FIG. 8 illustrates one embodiment of a flow 800 utilizing the timing rule of equation 2 and the input capacitance of equation 4. The exponents of equations 2, 4, and 5 are generally derived prior to the flow of FIG. 8. (In alternate embodiments, though, the exponents can be derived during the flow of FIG. 8.) Initially, as discussed above, an integrated circuit design may be broken down into smaller design blocks. These design blocks may exist at various levels on the design. For example, one design block might refer to an adder and a second design block might refer to a MUX, while each of the adder and MUX may be comprised of smaller design blocks. Therefore, flow 800 may be run at various levels of the integrated circuit.

The chosen design blocks are input into a circuit simulator (block 808), such as, for example, Spice. Alternate embodiments may use any other appropriate circuit simulators. Along with the design blocks is a technology file defining various aspects of the design that is also input to the circuit simulator (block 804). For example, the technology file generally contains the transistor and metallization characteristics for the technology being used. For example, the technology files can include circuit simulator models, such as, for example, Spice models. In addition to the design block and the technology file, control values are generated and input into the circuit simulator (block 806). Therefore, the circuit simulator runs on the design block using the technology file and chosen control values (block 808) in order to produce data which is then collected (block 810). In one embodiment, the control values include various operating points corresponding to various values of Tx, Cl, metallization RC, Vdd, process, and temperature. For example, in one embodiment utilizing the timing rule of equation 2 and CapI of equation 4, the control values include the 21 operating points chosen for deriving the constants of the equations. If different operating points were chosen for CapI, the control values would also include these operating points. In alternate embodiments utilizing the setup/hold time equation, the control values would also include the 14 operating points chosen for deriving the constants of equation 5.

Alternate embodiments may include different types of operating points than those listed above (Tx, Cl, metallization RC, Vdd, process, and temperature), depending on the needs of the equations being derived and analyzed. Also, different values of these operating points may be used during each run of a circuit simulator to produce data at various operating points. Therefore, the control values depend on the types of operating points, the values of these operating points, and the number of operating points desired to derive the equation constants. Thus, the use of different timing equations and input capacitance equations may require different control values.

For example, in one embodiment, there are 21 equation constants (as found in equation 2) which need to be determined that correspond to each design block. Therefore, 21 runs through the circuit simulator must be performed in order to collect data at 21 different points. For example, a first run through the circuit simulator may produce data corresponding to a specific operating point while a second run of the simulator using different control values will produce data corresponding to a different operating point. This may be done as many times as necessary in order to collect enough data to derive the equation constants of equation 2. For example, in the embodiment utilizing equation 2, once 21 runs are performed with data collected for each of these runs (blocks 810 and 812), the equation constants are derived (block 812). The results of collecting data produces 21 equations with 21 unknowns which may then be solved using matrix calculations to determine the 21 unknowns. Therefore, the constants of equation 2 are substituted with actual values corresponding to the particular design block being simulated. This process may be performed for each design block of the integrated circuit in order to derive a timing rule equation (in the form of equation 2) for each block.

In one embodiment, the same data collected in block 810 for deriving the constants for equation 2 (delay) are used to derive the constants for equation 4 (CapI) or equation 5 (setup/hold time). Alternate embodiments may collect different data for determining the constants for CapI or setup/hold time if, for example, different operating points are chosen than those used for delay. Therefore, some embodiments may collect data for more than one equation (e.g. for both delay and CapI) in block 810 and then derive the equation constants for the equations in block 812. Alternate embodiments may first collect data for one equation (equation 2, 4, or 5) and then perform different runs through the circuit simulator to collect data on another equation (equation 2, 4, or 5). That is, blocks 808, 810, and 812 can be performed separately for each equation being utilized. Also, more or less runs through the circuit simulator may be required depending upon the number of constants being derived.

These delay, CapI, and setup/hold time equations may then be used to perform timing analysis (block 814) such as static timing analysis on the integrated circuit design. For example, the timing of a path from one latch (i.e. one design block) to a second latch (i.e. a second design block) may be calculated by adding each of the delays at each block between the two latches, including the setup/hold times for each block, in order to get the total path delay. Each equation allows the timing analyzer to input the corresponding operating point. Therefore, even though an initial operating point may have been chosen in the initial design, these operating points may be changed and analyzed later in the design phase using these timing delay equations (such as equation 2, 4, and 5) that allow the user to input various operating parameters (e.g. Tx, Cl, metallization RC, process, temperature, supply voltage, or the like). Also, timing analysis may be performed with a subset of equations 2, 4, and 5 depending on the accuracy desired. For example, the delay time may be calculated using only the delay time equation (equation 2) while a fixed setup/hold time value or a fixed CapI value is used.

Once a timing analysis is performed to determine whether the paths conform with the speed of the device, the design may be modified (block 816) by changing one or more of the operating parameters. Therefore, subsequent timing analyses (block 814) may be performed without having to rederive the equation constants for each design block. That is, if a change in supply voltage (Vdd) is desired and the user wishes to analyze the effects of a change in supply voltage on the timing of the integrated circuit, the user may simply input the different supply voltage value into the delay, CapI, and setup/hold time equations to determine a new path delay depending upon the new supply voltage value. In the prior art systems discussed previously (e.g. the Five Coefficient Timing Rule equation), if the user wished to change a value in the supply voltage, entirely new constants had to be determined by rerunning the circuit simulator to collect new data because the previous timing rule equations were not dependent upon the supply voltage. Therefore, the user had no option to modify the supply voltage without having to derive new constants for each circuit block. Each of the Five Coefficient Timing Rule equations corresponded to a single operating point at a same supply voltage value. The same applies for the other control values discussed above such as metallization RC, process, temperature, and the like. That is, using a timing rule such as that given by equation 2, the user can change the value of any of these processing parameters.

Therefore, the equations (such as equations 2, 4, and 5) may be used to determine whether the design complies with the speed of the parts, as well as to allow for modifications in control values to improve the nominal operating point. That is, better performance may be achieved by varying some of the control values that effect the sensitivity of the design. The results of the timing analysis using equations such as equations 2, 4, and 5 may also help the user identify which design blocks in the integrated circuit are most sensitive to a change in processing parameters. Therefore, only those design blocks that are most sensitive may be redesigned. Upon their redesign, the circuit simulator is once again run enough times to collect enough data to derive new equation constants. However, it is only necessary to run the circuit simulator on the redesigned block as opposed to having to derive new equation constants for every block in the integrated circuit design. Since the equations derived for the other blocks in the design allow for change in process parameters, new constants do not need to be derived unless their actual design is modified. Once the design is complete, an integrated circuit may be manufactured (block 818).

Therefore, it can be appreciated how the timing rule of equation 2, the CapI of equation 4, and the setup/hold time of equation 5 can improve time to market performance and thereby reduce cost. For example, the design might be modified with respect to some of the processing parameters such as not only input edge rate and output capacitive load, but with respect to processing parameters such as temperature, supply voltage, process, and metallization. Therefore, once the simulator is run and sufficient data are collected to determine the constants, these equations may be used to vary these processing points. Also, while equations 2, 4, and 5 are of a specific format, alternate embodiments may have more or less terms, and terms that differ from those given, depending on which operating points the equations depend on, the accuracy desired, and the like.

Although the invention has been described with respect to specific conductivity types or polarity of potentials, skilled artisans appreciated that conductivity types and polarities of potentials may be reversed.

The various methods and techniques described herein such as, for example, the flow of FIG. 8, the derivation of the constants and exponents, the timing analysis, etc. may be implemented in software executing on a processor. Such software is stored in a computer readable medium (i.e. a machine readable medium), and the software includes a plurality of instructions that, when executed, cause the processor to perform the functions included in the method or technique. The processor is operably coupled to the computer readable medium and retrieves the plurality of instructions for execution. Such software may be embodied on one or more of computer hard disks, floppy disks, 3.5″ disks, computer storage tapes, magnetic drums, static random access memory (SRAM) cells, dynamic random access memory (DRAM) cells, electrically erasable (EEPROM, EPROM, flash) cells, nonvolatile cells, ferroelectric or ferromagnetic memory, compact disks (CDs), laser disks, optical disks, and any like computer readable media.

In the foregoing specification, the invention has been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

1. A method for making an integrated circuit, comprising:
providing a circuit simulator having the capability of simulating changes to at least one of power supply voltage, distributed capacitance, distributed resistance, transistor performance, and temperature;
providing a first circuit design;
providing an equation which comprises a plurality of variables and constants, wherein the plurality constants are unknown constants and one of the variables is related to at least one of power supply voltage, distributed capacitance, distributed resistance, transistor performance, and temperature;
applying the circuit simulator to the first circuit design to derive a first set of constants for the plurality of constants; and
replacing the unknown constants with the first set of constants to obtain a performance model of the first circuit design;
running experiments using the performance model of the first circuit design;
changing the first circuit design to obtain a second circuit design; and
making an integrated circuit comprising the second circuit design.

2. The method of claim 1, further comprising:
applying the circuit simulator to the second circuit design to derive a second set of constants for the plurality of constants; and
replacing the first set of constants with the second set of constants to obtain a performance model of the second circuit design; and
running experiments using the performance model of the second circuit design.

3. The method of claim 1 wherein the plurality of variables are related to power supply voltage, metallization capacitance, metallization resistance, transistor performance, and temperature.

4. The method of claim 1, wherein the equation comprises a plurality of delay expressions.

5. The method of claim 4, wherein the delay expressions comprise:
a metallization resistance and metallization capacitance delay.

6. The method of claim 4, wherein the delay expressions comprise:
a metallization resistance and load capacitance delay.

7. The method of claim 4, wherein the delay expressions comprise:
a transistor impedance and metallization capacitance delay.

8. The method of claim 4, wherein the delay expressions comprise:
an input edge rate and metallization capacitance delay.

9. The method of claim 4, wherein the delay expressions comprise:
a transistor performance as a function of process technology and power supply voltage delay.

10. The method of claim 4, wherein the delay expressions comprise:
a transistor performance as a function of process delay.

11. The method of claim 4, wherein the delay expressions comprise:
a power supply voltage dependent delay.

12. The method of claim 4, wherein the delay expressions comprise:
a temperature dependent delay.

13. The method of claim 1, wherein the equation comprises a plurality of capacitance expressions.

14. The method of claim 13, wherein the capacitance expressions comprise:
a transistor process technology dependent capacitance.

15. The method of claim 13, wherein the capacitance expressions comprise:
a power supply voltage dependent capacitance.

16. The method of claim 13, wherein the capacitance expressions comprise:
a temperature dependent capacitance.

17. The method of claim 13, wherein the capacitance expressions comprise:
a metallization capacitance dependent capacitance.

18. The method of claim 13, wherein the capacitance expressions comprise:
a metallization resistance dependent capacitance.

19. The method of claim 13, wherein the capacitance expressions comprise:
an output load dependent capacitance.

20. The method of claim 13, wherein the capacitance expressions comprise:
an input edge rate dependent capacitance.

21. The method of claim 13, wherein the capacitance expressions comprise:
a power supply voltage and transistor process technology dependent capacitance.

22. The method of claim 13, wherein the capacitance expressions comprise:
a power supply voltage and temperature dependent capacitance.

23. The method of claim 13, wherein the capacitance expressions comprise:
a transistor process technology and temperature dependent capacitance.

24. The method of claim 13, wherein the capacitance expressions comprise:
a power supply voltage, transistor process technology, and temperature dependent capacitance.

25. The method of claim 1, wherein the equation comprises a plurality of setup/hold time expressions.

26. The method of claim 25, wherein setup/hold time expressions comprise:
an input edge rate dependent setup/hold time.

27. The method of claim 25, wherein setup/hold time expressions comprise:
a reference signal input edge rate dependent setup/hold time.

28. The method of claim 25, wherein setup/hold time expressions comprise:
a transistor process technology dependent setup/hold time.

29. The method of claim 25, wherein setup/hold time expressions comprise:
a power supply voltage dependent setup/hold time.

30. The method of claim 25, wherein setup/hold time expressions comprise:
a temperature dependent setup/hold time.

31. The method of claim 25, wherein setup/hold time expressions comprise:
a metallization resistance dependent setup/hold time.

32. The method of claim 25, wherein setup/hold time expressions comprise:
a metallization capacitance dependent setup/hold time.

33. The method of claim 25, wherein setup/hold time expressions comprise:
an output load dependent setup/hold time.

34. The method of claim 25, wherein setup/hold time expressions comprise:
a transistor process technology and power supply voltage dependent setup/hold time.

35. The method of claim 25, wherein setup/hold time expressions comprise:
a metallization resistance and a metallization capacitance dependent setup/hold time.

36. A machine readable medium have stored therein information comprising:
an equation which comprises a plurality of variables and constants, wherein the plurality constants are unknown constants and one of the variables is related to at least one of power supply voltage, distributed capacitance, distributed resistance, transistor performance, and temperature; and
means for replacing the unknown constants with the first set of constants to obtain a performance model of the first circuit design.

37. A method for obtaining a performance model, comprising:
providing a circuit simulator having the capability of simulating changes to at least one of power supply voltage, distributed capacitance, distributed resistance, transistor performance, and temperature;
providing a path comprising a first design block, a second design block, and an interconnect coupling the first design block to the second design block;
providing an equation which comprises a plurality of variables and constants, wherein the plurality constants are unknown constants and one of the variables is related to at least one of power supply voltage, distributed capacitance, distributed resistance, transistor performance, and temperature;
applying the circuit simulator to the first and second design blocks to derive a first and second set of constants for the plurality of constants;
replacing the unknown constants with the first set of constants to obtain a first performance model of the first design block and the second set of constants to obtain a second performance model of the second design block;
modeling the path using the first performance model and the second model;
changing the design of at least one of the interconnect, the first design block, and the second design block to obtain a revised path; and
making an integrated circuit comprising the revised path.
